(19) United States
(12) Patent Application Publication
(10) Pub. No.: US 2009/0196817 A1
(43) Pub. Date: Aug. 6, 2009

(54) METHOD FOR MAKING A COPPER INDIUM CHALCOGENIDES POWDER

(76) Inventors: Richard FU, Kaohsiung County (TW); Wen-Chi HUANG, Tainan City (TW); Bang-Yen CHOU, Tainan City (TW); Shih-Jen LIN, Kaohsiung County (TW); Chun-Hui C. C. CHEN, Tainan County (TW)

Correspondence Address: OSTROLENK FABER GERB & SOFFEN, 1180 AVENUE OF THE AMERICAS, NEW YORK, NY, 100368403, US

(21) Appl. No.: 12/249,194

(22) Filed: Oct. 10, 2008

(30) Foreign Application Priority Data
Jan. 31, 2008 (TW) 097103740
Jan. 31, 2008 (TW) 097103743

(51) Int. Cl. C01B 19/00

(52) U.S. Cl. 423/508

(57) ABSTRACT

A method for making a copper indium chalcogenides powder, includes: (a) reacting a reactant mixture that contains a Cu-containing material, an In-containing material, and a chalcogenides-containing material in a polar organic solvent at an elevated temperature so as to form a precipitate, the polar organic solvent having a molecular structure containing at least one of nitrogen atom and oxygen atom, each of which having at least one lone electron pair, the polar organic solvent further having a dipole moment greater than 2.3 debye; and (b) separating the polar organic solvent from the precipitate.

### CROSS-REFERENCE TO RELATED APPLICATION

This application claims priorities of Taiwanese Application No. 097103740, filed on Jan. 31, 2008, and Taiwanese Application No. 097103743, filed on Jan. 31, 2008.

### BACKGROUND OF THE INVENTION

1. Field of the Invention

This invention relates to a method for making a copper indium chalcogenides powder, more particularly to a method involving reacting a reactant mixture in a polar organic solvent for making a copper indium chalcogenides powder.

2. Description of the Related Art

Copper indium chalcogenides materials, such as CuInSe₂, Cu(InₓGa₁₋ₓ) (Se_{y}S_{2-y}), and Cu(InₓAl₁₋ₓ) (Se_{y}S_{2-y}), are used in the production of a p-type semiconductor absorption layer of a solar cell due to their high optoelectric efficiency and low cost.

Claire J. Carmalt et. al (J. Master. Chem., 1998, 8(10), 2209-2211) disclose a method for making a copper indium chalcogenides powder. The method includes dissolving a mixture of CuBr, InCl₃, and Na₂Se in a solvent of C₇H₈ for about 72 hr, refluxing the mixture, and removing the solvent from the mixture so as to obtain a solid compound. Subsequently, the solid compound is subjected to an annealing treatment under a temperature of 500° C. for 24 hr so as to form the copper indium chalcogenides powder having a structure of a chalcopyrite phase. However, the copper indium chalcogenides powder thus formed still contains a significant amount of undesired sphalerite phase in the structure, which has an adverse effect on the optoelectric efficiency.

Bin Li et al. (ADv. Mater, 1999, 11, No. 17, 1456-1459) disclose a solvothermal synthesis method for making CuInSe₂ nano-materials. A mixture of CuCl₂.2H₂O, InCl₃.4H₂O, and Se is dissolved in a solvent of hydrous dimethylamine or ethylenediamine in an autoclave, and then the autoclave is closed and maintained at a temperature of 180° C. for 15 hr to subject the mixture to reaction to form a precipitate. After cooling the autoclave to room temperature, the precipitate thus formed is rinsed by water and ethanol for several times so as to remove by-product from the precipitate. Finally, the precipitate is dried under a temperature of 60° C. for 4 hr in a vacuum environment so as to form the copper indium chalcogenides powder having a structure of a chalcopyrite phase. However, the copper indium chalcogenides powder thus formed still contains a significant amount of the undesired sphalerite phase. In addition, the reaction system requires to be conducted in an autoclave, which results in an increase in the manufacturing costs.

### SUMMARY OF THE INVENTION

Therefore, an object of the present invention is to provide a method for making a copper indium chalcogenides powder that can overcome the aforesaid drawbacks associated with the prior art.

According to the present invention, a method for making a copper indium chalcogenides powder comprises: reacting a reactant mixture that contains a Cu-containing material, an In-containing material, and a chalcogenides-containing material in a polar organic solvent at an elevated temperature so as to form a precipitate of the copper indium chalcogenides in the polar organic solvent, the polar organic solvent having a molecular structure containing at least one of nitrogen atom and oxygen atom, each of which having at least one lone electron pair, the polar organic solvent further having a dipole moment greater than 2.3 debye; and (b) separating the polar organic solvent from the precipitate so as to obtain the copper indium chalcogenides powder.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is an X-ray diffraction graph of a copper indium chalcogenides powder of Example 1 of the preferred embodiment according to this invention;

FIG. 2 is an X-ray diffraction graph of the copper indium chalcogenides powder of Example 2 of the preferred embodiment;

FIG. 3 is an X-ray diffraction graph of the copper indium chalcogenides powder of Example 3 of the preferred embodiment;

FIG. 4 is an X-ray diffraction graph of the copper indium chalcogenides powder of Example 4 of the preferred embodiment;

FIG. 5 is an X-ray diffraction graph of the copper indium chalcogenides powder of Example 5 of the preferred embodiment;

FIG. 6 is an X-ray diffraction graph of the copper indium chalcogenides powder of Example 6 of the preferred embodiment;

FIG. 7 is an X-ray diffraction graph of the copper indium chalcogenides powder of the preferred embodiment of Example 7;

FIG. 8 is an X-ray diffraction graph of the copper indium chalcogenides powder of Example 8 of the preferred embodiment;

FIG. 9 is an X-ray diffraction graph of the copper indium chalcogenides powder of Example 9 of the preferred embodiment;

FIG. 10 is an X-ray diffraction graph of the copper indium chalcogenides powder of Example 10 of the preferred embodiment;

FIG. 11 is an x-ray diffraction graph of the copper indium chalcogenides powder of Comparative Example 1;

FIG. 12 is an X-ray diffraction graph of the copper indium chalcogenides powder of Comparative Example 2;

FIG. 13 is an X-ray diffraction graph of a copper indium chalcogenides target of Example 11 of the preferred embodiment according to this invention; and

FIG. 14 is an X-ray diffraction graph of a copper indium chalcogenides thin film of Example 12 of the preferred embodiment according to this invention.

### DETAILED DESCRIPTION OF THE PREFERRED EMBODIMENT

The preferred embodiment of a method for making a copper indium chalcogenides powder according to this invention includes the steps of: reacting a reactant mixture that contains a Cu-containing material, an In-containing material, and a chalcogenides-containing material in a polar organic solvent at an elevated temperature so as to form a precipitate of the copper indium chalcogenides in the polar organic solvent, the polar organic solvent having a molecular structure containing at least one of nitrogen atom and oxygen atom, each of which having at least one lone electron pair, the polar organic solvent further having a dipole moment greater than 2.3 debye; and (b) separating the polar organic solvent from the precipitate so as to obtain the copper indium chalcogenides powder.

The lone electron pair of said at least one of the nitrogen atom and the oxygen atom of the molecular structure of the polar organic solvent can chelate with the copper of the Cu-containing material so as to facilitate reaction of the Cu-containing material, the In-containing material, and the chalcogenides-containing material. In addition, since the polar organic solvent has a dipole moment greater than 2.3 debye, i.e., having a relatively high polarity, the Cu-containing material, the In-containing material, and the chalcogenides-containing material, which are ionic reactants, can be easily and completely dissolved therein. As a consequence, the reaction of the reactant mixture can be conducted under a homogeneous phase so as to enhance collision probability of the reactants and so as to improve the reaction rate.

Preferably, the solvent has a dipole moment greater than 3.5 debye.

It is noted that the polar organic solvent suitable for use in the invention can be a non-ionic liquid, such as dimethyl formamide, dimethylacetamide, dimethyl sulfoxide, N-methylpyrrolidone, pyridine, or an ionic liquid, such as 1-Butyl-3-methylimidazolium hexafluorophosphate, 1-Butyl-3-methylimidazolium chloride, and combinations thereof. Preferably, the solvent is selected from the group consisting of dimethyl formamide, 1-Butyl-3-methylimidazolium hexafluorophosphate, and combinations thereof.

In this embodiment, the reaction in step (a) is conducted by reflux reaction under an inert gas environment.

Preferably, the inert gas in the inert gas environment is selected from the group consisting of N₂, Ar, He, and combinations thereof.

In some embodiments, the reflux reaction time is not less than 4 hr. Preferably, the reflux reaction time ranges from 4 to 48 hr, and more preferably, ranges from 8 to 48 hr.

In some embodiments, the reflux reaction is under a temperature ranging from 90 to 300° C., and more preferably, ranging from 120 to 300° C.

In some embodiments, the solvent is in an amount ranging from 50% to 90% by volume based on the total volume of a reactor.

In some embodiments, the Cu-containing material is selected from the group consisting of CuCl₂, CuCl₂.2H₂O, CuSO₄, and combinations thereof.

In some embodiments, the In-containing material is selected from the group consisting of InCl₃.4H₂O, In₂O₃, In(NO₃)₃, and combinations thereof.

In some embodiments, the chalcogenides-containing material is selected from the group consisting of Se, Na₂Se, S, and combinations thereof.

In some embodiments, the Cu-containing material, the In-containing material, and the chalcogenides-containing material have a molar concentration ratio ranging from 0.9:1.1:1.9 to 1.1:0.9:2.2.

In one embodiment, the reactant mixture further includes a Ga-containing material.

Preferably, the Cu-containing material, the In-containing material, the Ga-containing material, and the chalcogenides-containing material have a molar concentration ratio ranging from 0.9:0.88:0.22:2.2 to 1.1:0.72:0.18:1.9.

Preferably, the Ga-containing material is selected from the group consisting of Ga, GaCl₃, and combinations thereof.

This invention also provides a method for making a copper indium chalcogenides target. The method includes the aforesaid steps (a) and (b) and further includes the steps of: (c) placing the copper indium chalcogenides powder in a cavity in a mold (not shown); (d) vacuuming the cavity in the mold; (e) heating the copper indium chalcogenides powder and applying a pressure to the mold such that the mold presses against the copper indium chalcogenides powder so as to form a sintered product; and (f) releasing the pressure applied to the mold and cooling the mold prior to removal of the sintered product from the mold.

In this embodiment, the cooling of the mold in step (f) is conducted by introducing a coolant of an inert gas to pass through the cavity.

Note that when the pressure applied to the mold is too high, undesired conversion of the copper indium chalcogenides into other compounds is likely to occur during formation of the copper indium chalcogenides target.

Preferably, the cavity in step (d) is vacuumed to a vacuum pressure ranging from 10⁻² torr to 10⁻⁵ torr.

In some embodiments, the heating in step (e) is under a heating rate ranging from 2° C./min to 10° C./min, and the pressure applied to the mold in step (e) is gradually raised under a rate ranging from 1 Mpa/min to 3 Mpa/min.

It is noted that the operating conditions in step (e) considerably affect densification of the sintered product. When a predetermined temperature, pressure or processing time is insufficient, the structure of the sintered product becomes relatively loose. In contrast, when the temperature, pressure or processing time is too high, the process becomes ineffective. In addition, when the temperature is too high, an undesired δ-phase of the copper indium chalcogenides target can be formed due to a phase transition. Preferably, the copper indium chalcogenides powder is heated in step (e) to a temperature ranging from 500° C. to 800° C., and the pressure applied to the mold is raised in step (e) to a pressure ranging from 60 Mpa to 180 Mpa for 1 to 8 hr.

This invention further provides a copper indium chalcogenides thin film formed on a substrate (not shown) by sputtering of the copper indium chalcogenides target under an inert gas environment.

During sputtering, when the inert gas pressure is too high, deposition of the copper indium chalcogenides plasma is adversely affected by excessive inert gas, which results in a poor deposition rate and poor crystallization of the copper indium chalcogenides. On the contrary, when the inert gas pressure is too low, the inert gas is insufficient, thereby resulting in a decrease in a disassociated rate of the inert gas, which results in failure of the deposition. Preferably, the inert gas pressure ranges from 1 mtorr to 50 mtorr.

In addition, when an output power applied on the target is too high during sputtering, the deposition rate can be improved but an adhesion between the thin film and the substrate will decrease. On the contrary, when the output power is too low, a deposition time will be prolonged due to the low deposition rate. Preferably, the output power ranges from 20 W to 300 W, more preferably, from 20 W to 150 W.

Moreover, when a substrate temperature is too low during sputtering, a problem, such as breaking of the thin film, will occur due to a temperature difference between the substrate and the high-temperature plasma. Preferably, the substrate temperature ranges from 25° C. to 450° C., more preferably, from 120° C. to 350° C.

Furthermore, when a distance between the target and the substrate is too small during sputtering, the substrate can be undesirably raised to a relatively high temperature by direct contact with the high-temperature plasma, which results in cracking of the thin film formed on the substrate due to a difference in the thermal expansion coefficients between the substrate and the thin film. Preferably, the distance ranges from 5 cm to 15 cm.

The merits of the method for making the copper indium chalcogenides powder of this invention will become apparent with reference to the following Examples and Comparative Examples.

### EXAMPLE

### Example 1 (E1)

A reactant mixture of 102.96 g CuCl, 243.36 InCl₃.4H₂O, 14.36 g Ga, and 164.32 g Se in a mole ratio of 1:0.8:0.2:2, was dissolved in a solvent of 1200 ml dimethyl formamide (DMF) in a N₂ environment. Subsequently, the reactant mixture was stirred under a stirring rate of 300 rpm and refluxed under a temperature of 180° C. for 48 hr so as to form a copper indium chalcogenides precipitate. After drying the copper indium chalcogenides precipitate, the copper indium chalcogenides powder thus formed has a formula of CuIn_{0.8}Ga_{0.2}Se₂, a weight of about 339.77 g, and an average diameter ranging from about 1 μm to about 5 μm.

### Example 2 (E2)

The process conditions of Example 2 were similar to those of Example 1, except that the reactant mixture was without the Ga, and that the mole ratio of CuCl, InCl₃.4H₂O, and Se was 1:1:2. The copper indium chalcogenides powder thus formed has a formula of CuInSe₂ and a weight of about 349.44 g.

### Example 3 (E3)

The process conditions of Example 3 were similar to those of Example 1, except that InCl₃.4H₂O was replaced by In₂O₃. The copper indium chalcogenides powder thus formed has a formula of CuIn_{0.8}Ga_{0.2}Se₂ and a weight of about 339.47 g.

### Example 4 (E4)

The process conditions of Example 4 were similar to those of Example 1, except that InCl₃.4H₂O was replaced by In(NO₃)₃. The copper indium chalcogenides powder thus formed has a formula of CuIn_{0.8}Ga_{0.2}Se₂ and a weight of about 339.77 g.

### Example 5 (E5)

The process conditions of Example 5 were similar to those of Example 1, except that Se was replaced by Na₂Se, and that the mole ratio of CuCl, InCl₃.4H₂O, Ga, and Na₂Se was 0.9:0.88:0.22:2.2. The copper indium chalcogenides powder thus formed has a formula of Cu_{0.9}In_{0.88}Ga_{0.22}Se_{2.2} and a weight of about 360.54 g.

### Example 6 (E6)

The process conditions of Example 6 were similar to those of Example 1, except that CuCl was replaced by CuCl₂.2H₂O. The copper indium chalcogenides powder thus formed has a formula of CuIn_{0.8}Ga_{0.2}Se₂ and a weight of about 339.77 g.

### Example 7 (E7)

The process conditions of Example 7 were similar to those of Example 1, except that CuCl and Se were replaced by CuCl₂.2H₂O and Na₂Se, respectively. The copper indium chalcogenides powder thus formed has a formula of CuIn_{0.8}Ga_{0.2}Se₂ and a weight of about 327.22 g.

### Example 8 (E8)

The process conditions of Example 8 were similar to those of Example 1, except that DMF solvent was replaced by 1-Butyl-3-methylimidazolium chloride ([bmim]Cl). The copper indium chalcogenides powder thus formed has a formula of CuIn_{0.8}Ga_{0.2}Se₂ and a weight of about 339.47 g.

### Example 9 (E9)

The process conditions of Example 9 were similar to those of Example 1, except that DME solvent was replaced by 1-Butyl-3-methylimidazolium hexafluorophosphate ([bmim]PF6). The copper indium chalcogenides powder thus formed has a formula of CuIn_{0.8}Ga_{0.2}Se₂ and a weight of about 339.47 g.

### Example 10 (E10)

The process conditions of Example 10 were similar to those of Example 1, except that DMF solvent was replaced by dimethyl sulfoxide (DMSO). The copper indium chalcogenides powder thus formed has a formula of CuIn_{0.8}Ga_{0.2}Se₂ and a weight of about 339.47 g.

### Comparative Example 1 (CE1)

The process conditions of Comparative Example 1 were similar to those of Example 1, except that DMF solvent was replaced by tetrahydrofuran (THF).

### Comparative Example 2 (CE2)

The process conditions of Comparative Example 2 were similar to those of Example 1, except that DMF solvent was replaced by chloroform (CHCl₃).

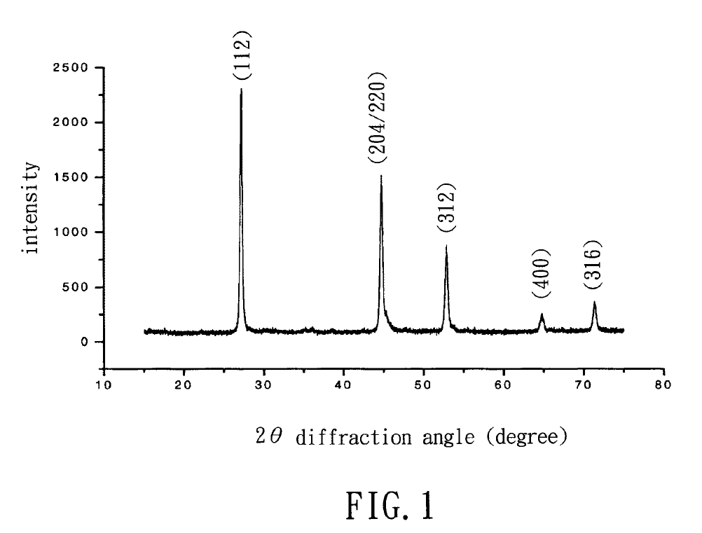

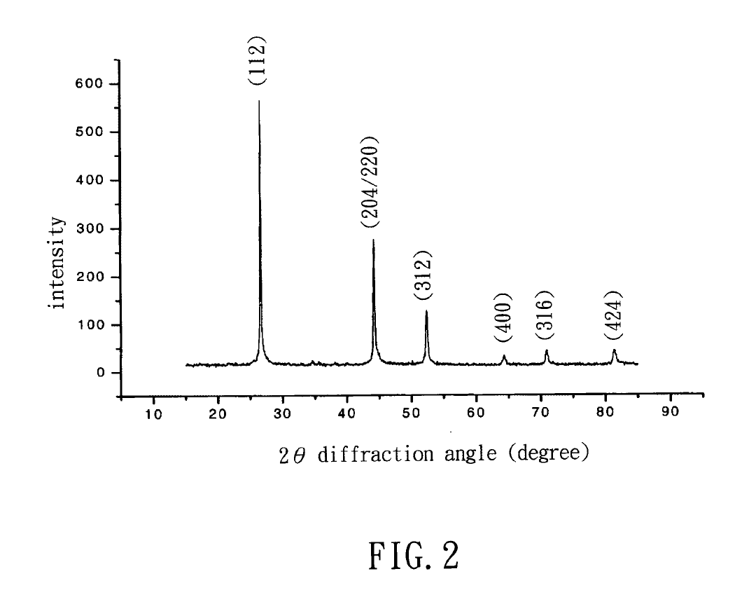

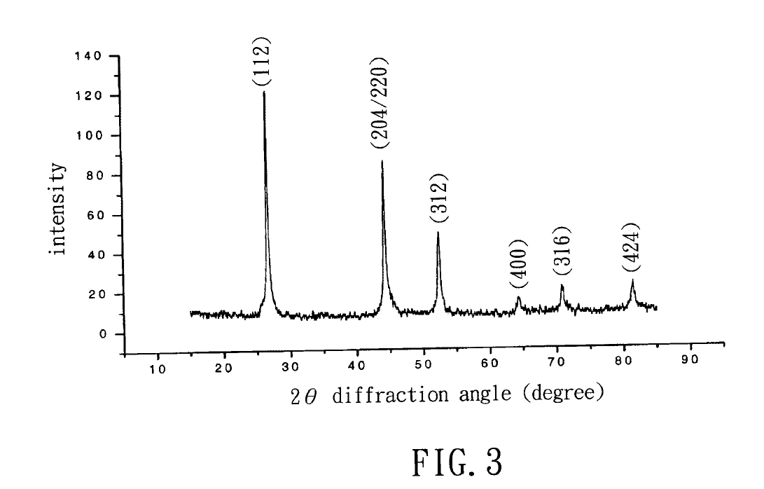

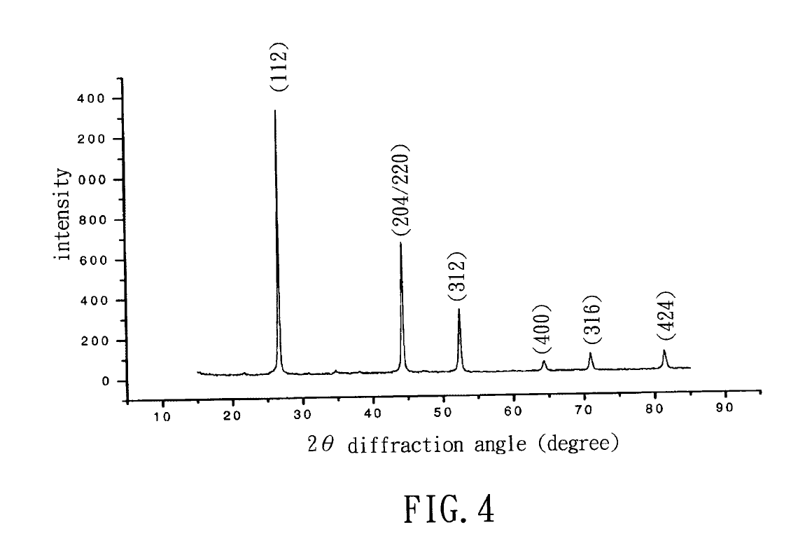

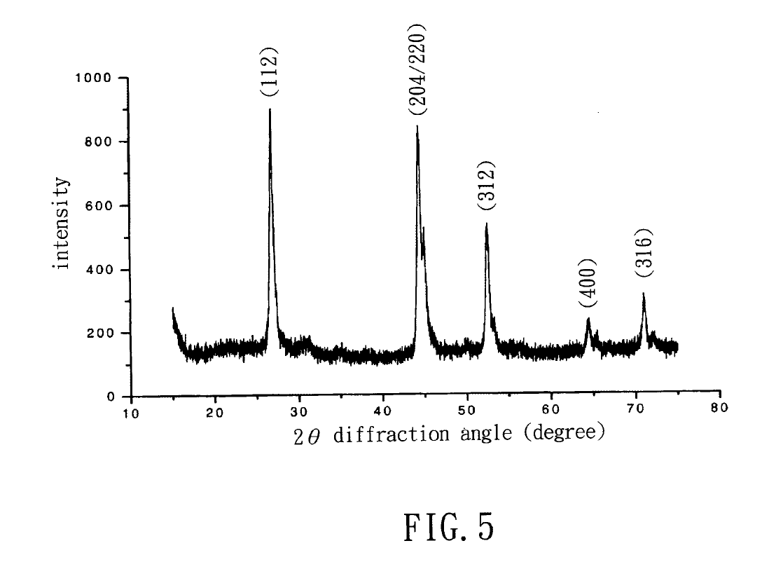

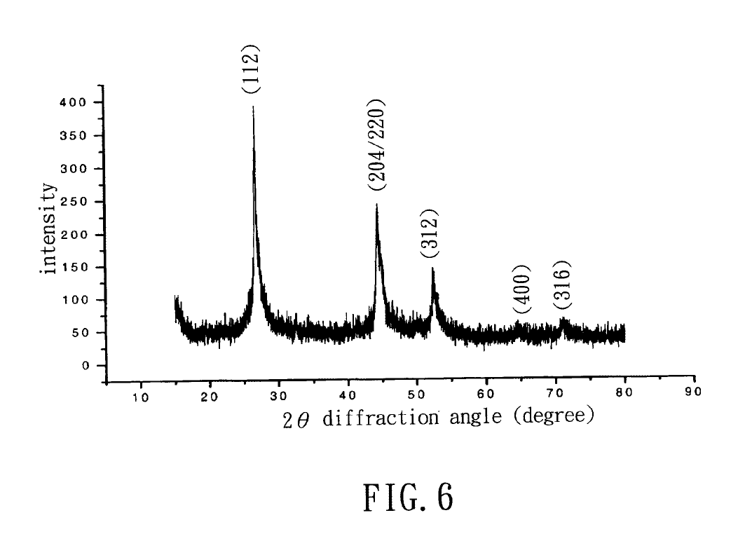

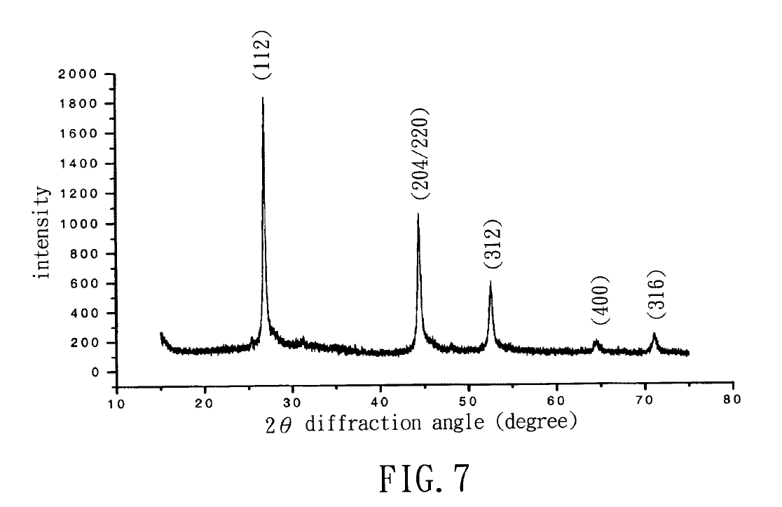

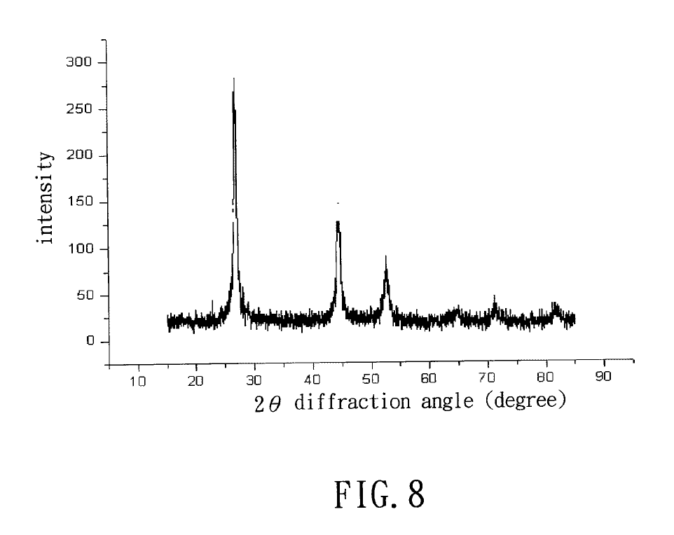

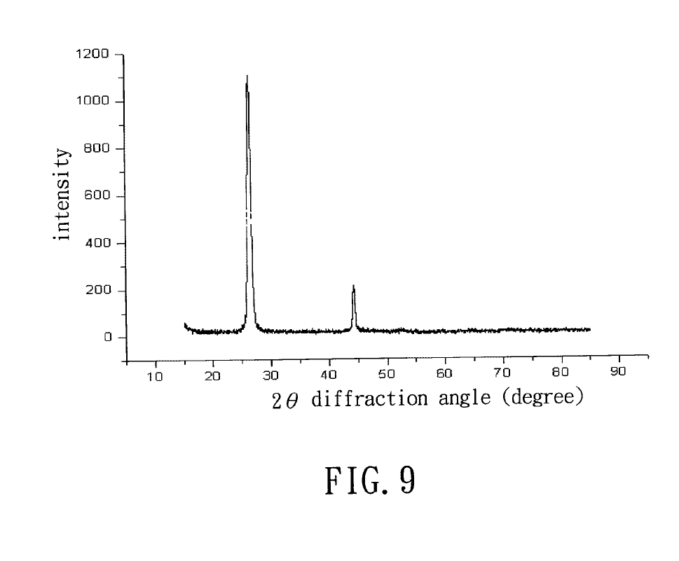

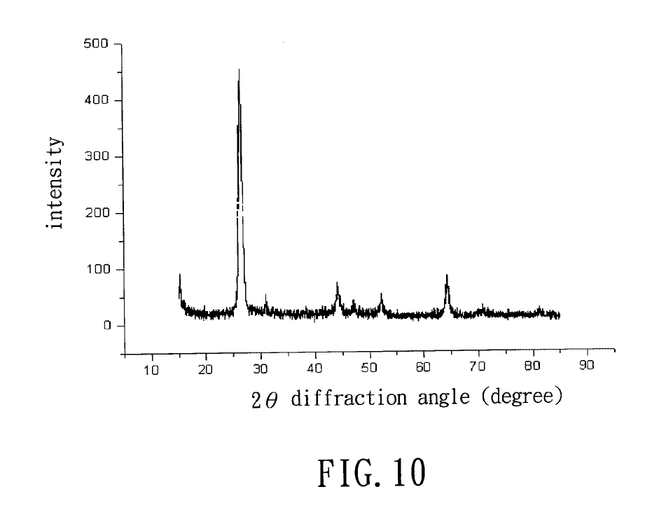

FIGS. 1 to 10 are X-ray diffraction graphs of Examples 1 to 10, respectively. In each graph of FIGS. 1 to 8, the left peaks 112, 204/220, 312 are chalcopyrite phase peaks of the copper indium chalcogenides at different crystal faces thereof, while the right peaks 400, 316, 424 are sphalerite phase peaks of the copper indium chalcogenides at different crystal faces thereof. The results show that the copper indium chalcogenides powders thus formed for Examples 1-8 have a single crystal structure of a chalcopyrite phase with a trace amount of sphalerite phase. FIGS. 9 and 10 show similar results, i.e. the copper indium chalcogenides powders thus formed for Examples 9 and 10 have a structure of a chalcopyrite phase with a trace amount of sphalerite phase.

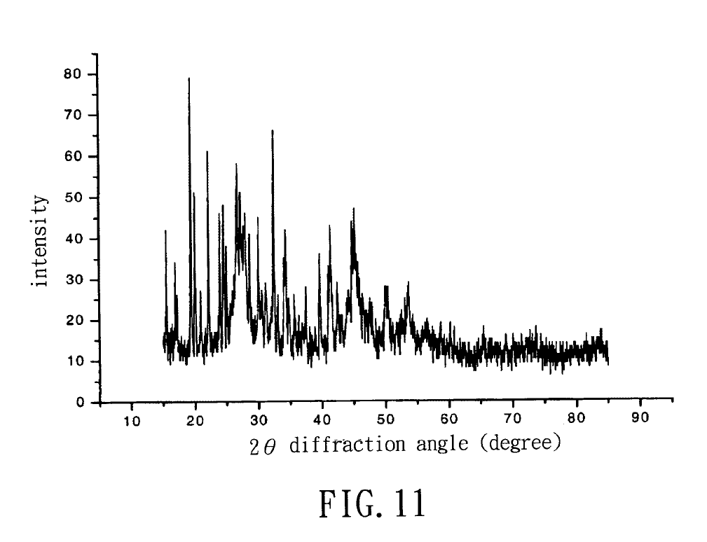

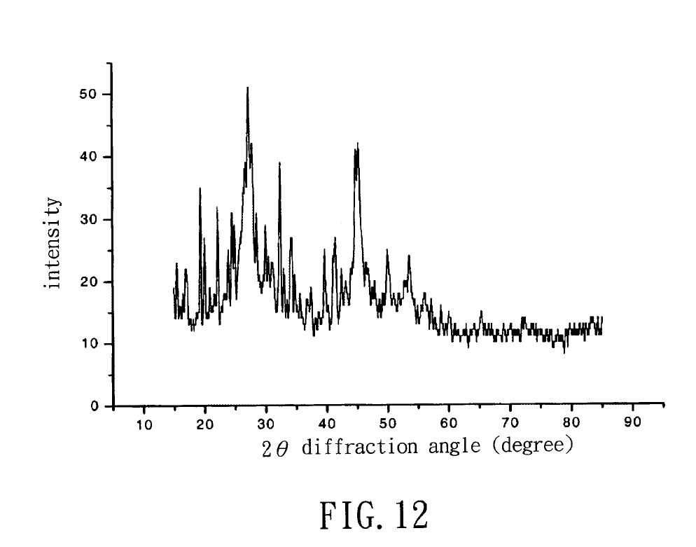

FIGS. 11 and 12 are X-ray diffraction graphs of Comparative Examples 1 and 2, respectively. The results show that no chalcopyrite phase peak of the copper indium chalcogenides for the Comparative Examples 1 and 2 was found in the graphs, which indicates that the copper indium chalcogenides was not formed in Comparative Examples 1 and 2.

### Making the Copper Indium Chalcogenides Target

### Example 11 (E11)

80 g of the copper indium chalcogenides powder formed from Example 6 were placed in a cavity of a mold. The cavity was vacuumed and the powder was heated under a heating rate of 5° C./min. After vacuuming the cavity to about 2×10⁻³ torr for approximately 1 hour, Ar gas was introduced into the cavity. The powder was then heated using the same heating rate of 5° C./min to a final temperature of 780° C., and the pressure applied to the mold was raised under a rate of 1.7 Mpa/min to a final pressure of 150 Mpa. The final temperature and the final pressure for thermally pressing the copper indium chalcogenides powder were maintained for 4 hr. After the thermal pressing, the pressure applied to the mold was released, and the copper indium chalcogenides powder was cooled in the Ar environment so as to form the copper indium chalcogenides target having a diameter of 3 inch and a thickness of 3 mm.

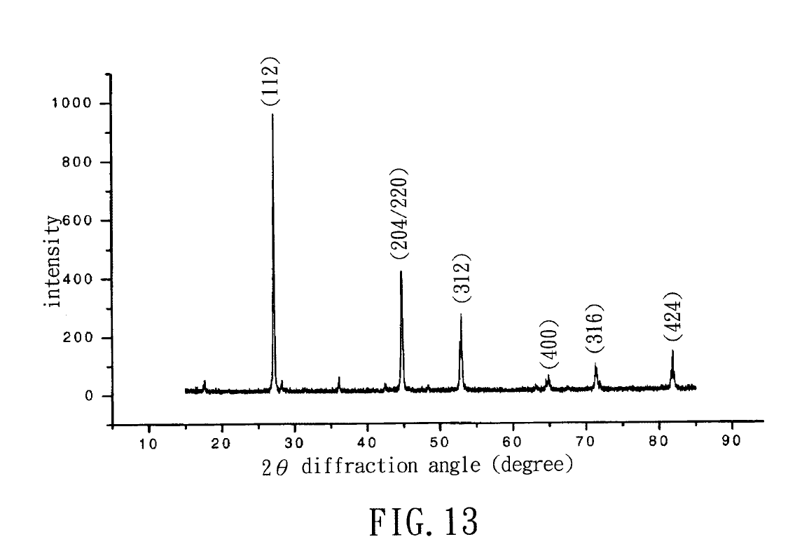

FIG. 13 is an x-ray diffraction graph of the copper indium chalcogenides target formed in Example 11. The results show that the copper indium chalcogenides target thus formed has a single crystal structure of the chalcopyrite phase with only a trace amount of the sphalerite phase.

### Making the Copper Indium Chalcogenides Thin Film

### Example 12 (E12)

A substrate was disposed in a sputtering chamber of a magnetron DC sputtering system under a working pressure of 8mtorr that was maintained by introducing Ar gas thereinto at a flow rate of 19 sccm. Subsequently, an output power of 75 W was applied on the copper indium chalcogenides target so as to form the copper indium chalcogenides thin film on the substrate. During sputtering, the substrate had a substrate temperature of 200° C. and was spaced apart from the target by a distance of 10 cm.

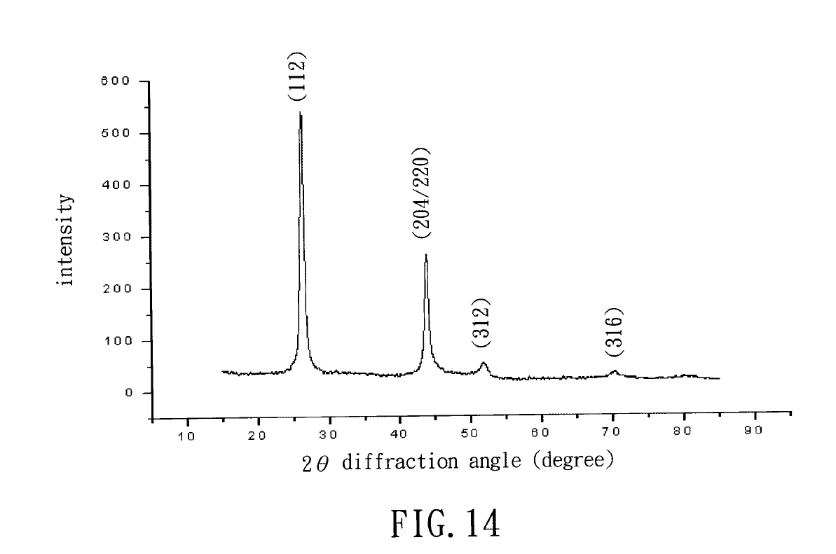

FIG. 14 is an X-ray diffraction graph of the copper indium chalcogenides thin film formed in Example 12. The results show that the copper indium chalcogenides thin film thus formed has a single crystal structure of the chalcopyrite phase with a trace amount of the sphalerite phase.

By reacting the reactant mixture in the polar organic solvent having a dipole moment greater than 2.3 debye and a molecular structure containing at least one of nitrogen atom and oxygen atom, each of which at least one lone electron pair, in the method of this invention, the aforesaid drawbacks associated with the prior art can be eliminated.

With the invention thus explained, it is apparent that various modifications and variations can be made without departing from the spirit of the present invention. It is therefore intended that the invention be limited only as recited in the appended claims.

What is claimed is:

1. A method for making a copper indium chalcogenides powder, comprising:
(a) reacting a reactant mixture that contains a Cu-containing material, an In-containing material, and a chalcogenides-containing material in a polar organic solvent at an elevated temperature so as to form a precipitate of the copper indium chalcogenides in the polar organic solvent, the polar organic solvent having a molecular structure containing at least one of nitrogen atom and oxygen atom, each of which having at least one lone electron pair, the polar organic solvent further having a dipole moment greater than 2.3 debye; and
(b) separating the polar organic solvent from the precipitate so as to obtain the copper indium chalcogenides powder.

2. The method of claim 1, wherein the polar organic solvent is selected from the group consisting of dimethyl formamide, dimethyl acetamide, dimethyl sulfoxide, N-methylpyrrolidone, pyridine, 1-Butyl-3-methylimidazolium hexafluorophosphate, 1-Butyl-3-methylimidazolium chloride, and combinations thereof.

3. The method of claim 1, wherein the polar organic solvent is selected from the group consisting of dimethyl formamide, 1-Butyl-3-methylimidazolium hexafluorophosphate, and combinations thereof.

4. The method of claim 1, wherein the reaction in step (a) is conducted by reflux reaction under an inert gas environment.

5. The method of claim 1, wherein the Cu-containing material is selected from the group consisting of CuCl₂, CuCl₂.2H₂O, CuSO₄, and combinations thereof.

6. The method of claim 1, wherein the In-containing material is selected from the group consisting of InCl₃.4H₂O, In₂O₃, In(NO₃)₃, and combinations thereof.

7. The method of claim 1, wherein the chalcogenides-containing material is selected from the group consisting of Se, Na₂Se, S, and combinations thereof.

8. The method of claim 1, wherein the Cu-containing material, the In-containing material, and the chalcogenides-containing material have a molar concentration ratio ranging from 0.9:1.1:1.9 to 1.1:0.9:2.2.

9. The method of claim 1, wherein the reactant mixture further contains a Ga-containing material.

10. The method of claim 9, wherein the Cu-containing material, the In-containing material, the Ga-containing material, and the chalcogenides-containing material have a molar concentration ratio ranging from 0.9:0.88:0.22:2.2 to 1.1:0.72:0.18:1.9.

11. The method of claim 9, wherein the Ga-containing material is selected from the group consisting of Ga, GaCl₃ and combinations thereof.

12. A copper indium chalcogenides target comprising a sintered body prepared by sintering the copper indium chalcogenides powder made according to the method of claim 1.

13. A copper indium chalcogenides film made from said copper indium chalcogenides target as set forth in claim 12 by sputtering of said copper indium chalcogenides target.
